(19) United States
(12) Patent Application Publication
(10) Pub. No.: US 2026/0113743 A1
(43) Pub. Date: Apr. 23, 2026

(54) ACCESS POINT MULTI-LINK DEVICE AND METHOD FOR WIRELESS COMMUNICATION

(71) Applicant: TP-Link Systems Inc., IRVINE, CA (US)

(72) Inventor: Qingwei FU, Shenzhen (CN)

(73) Assignee: TP-Link Systems Inc., IRVINE, CA (US)

(21) Appl. No.: 18/920,673

(22) Filed: Oct. 18, 2024

(51) Int. Cl. H04W 72/1263; H04W 40/00

(52) U.S. Cl. CPC H04W 72/1263; H04W 40/005

(57) ABSTRACT

The present disclosure provides a method and an access point multi-link device (AP MLD). An AP MLD according to the embodiment of the present disclosure includes a plurality of affiliated access points (APs), wherein in a multi-link scheduling power saving mode, each affiliated AP of the plurality of affiliated APs is in an awake state at a first scheduling information frame to transmit scheduling information on its link, wherein the scheduling information indicates one or more service periods (SPs) after the first scheduling information frame for the plurality of affiliated APs, wherein links of the plurality of affiliated APs are in the non-simultaneous transmit and receive (NSTR) operation mode, in each SP of the one or more SPs, only one affiliated AP in the plurality of affiliated APs is in an awake state after the first scheduling information frame.

### TECHNICAL FIELD

The present disclosure relates to wireless communication, and more specifically, to an access point multi-link device (AP MLD) and a method for wireless communication.

### BACKGROUND

Currently, the AP has evolved into multi-link devices (MLDs). In the next generation of AP products, multi-link is a necessary function. On the other hand, the additional links cause that the power consumption increases significantly. Therefore, there is a broad market demand and strong technical demand for AP multi-link power saving technology.

The next-generation Wi-Fi standard proposals for the AP MLD power saving are based on the situation in which both AP and the station (STA) are MLD devices. Specifically, in such power saving schemes, after the AP MLD establishes multiple links with the STA MLD, one link is kept in the active mode, that is, on the link in the active mode, the AP and STA are both in the awake state, while other links or APs of the AP MLD enter power-saving mode. The APs of the AP MLD in power saving mode do not send beacon frames or probe response frames. When the STA MLD has a large traffic transmission demand, it transmits a request frame on the active link. After receiving the request frame, the AP MLD activates all of the affiliated APs(links) to the STA MLD, and then transmits large traffic. Moreover, when the transmission is completed, the activated link or AP may enter the power-saving mode again if there is no other transmission demand. However, the above technique cannot be applied to the links to the non-MLD STA which are not connected with the AP MLD on the activated link.

### SUMMARY

In view of the above, the present disclosure an access point multi-link device (AP MLD) and a method for wireless communication.

According to an aspect of the present disclosure, there is an access point multi-link device (AP MLD), comprising a plurality of affiliated access points (APs), wherein in a multi-link scheduling power saving mode, each affiliated AP of the plurality of affiliated APs is in an awake state at a first scheduling information frame to transmit scheduling information on its link, wherein the scheduling information indicates one or more service periods (SPs) after the first scheduling information frame for the plurality of affiliated APsin each SP of the one or more SPs, only one affiliated AP in the plurality of affiliated APs is in an awake state.

In some embodiments, the links of the plurality of affiliated APs are in the non-simultaneous transmit and receive (NSTR) operation mode.

In some embodiments, the scheduling information indicates one or more of the following items related to the SPs: working states of the plurality of affiliated APs in the one or more SPs, wherein the working states include awake state and doze state, starting times of the one or more SPs, time durations of the one or more SPs, and TID-To-Link mapping element.

In some embodiments, the first scheduling information frame is associated with a first target beacon transmission time (TBTT).

In some embodiments, ends of the one or more SPs are aligned with TBTTs, respectively, and time durations of one or more SPs are determined based on an interval of the beacon frames.

In some embodiments, each affiliated AP of the plurality of affiliated APs is in the awake state at one or more TBTTs after the first scheduling information frame.

In some embodiments, the AP MLDschedules one or more STAs for being in the awake mode during the SP when an affiliated AP which associated with the one or more STAs is in awake state, with negotiating target wake time (TWT) agreements, and the first scheduling information frame is independent from a target beacon transmission time (TBTT).

In some embodiments, in the multi-link scheduling power saving mode, when a first affiliated AP is in the doze state, andthe first affiliated AP is associated with one or more non-MLD STAs that require low latency transimission service or associated with one or more legacy STAs in the awake state, the first affiliated AP switches to the lower capability mode in which a transmission capability of an AP is reduced. The one or more legacy STAs do not support the low latency traffic transmission.

In some embodiments, The AP MLD further comprises a processor configured to control the AP MLD to enter the multi-link scheduling power saving mode and schedule working states of the plurality of affiliated APs in the multi-link scheduling power saving mode, wherein the working states include the awake state and a doze state.

In some embodiments, in the multi-link scheduling power saving mode, the processor of the AP MLD is further configured to switch the plurality of affiliated APs to the awake state, in response to the request frame, when the affiliated AP in the awake state during an SP receives a request frame from an STAtion (STA) MLD.

In some embodiments, the processor of the AP MLD is further configured to control the AP MLD to enter the multi-link scheduling power saving mode based on a traffic load of the AP MLD, a transmission delay of the AP MLD, and/or a type of a non-AP STA associated with the AP MLD.

In some embodiments, in the multi-link scheduling power saving mode, the processor of the AP MLD is further configured to schedule a second affiliated AP to enter the awake state when one or more non-MLD STAs associated with the second affiliated AP enter the awake state.

In some embodiments, the scheduling information further indicates a number of the SPs corresponding to the scheduling information.

In some embodiments, the plurality of affiliated APs enter the awake state in a certain order during a plurality of successive SPs in the multi-link scheduling power saving mode.

In some embodiments, the order is determined based on one or more of the following items: a type of one or more STAs associated with each affiliated AP, a quantity of one or more STAs associated with each affiliated AP, a traffic load of one or more STAs associated with each affiliated AP.

In some embodiments, when a third affiliated AP is associated with one or more STAs and one or more STAs are in the active mode, the scheduling information includes a quiet element or TID-To-Link Mapping element for the third affiliated AP.

According to another aspect of the present disclosure, there is provided a method for wireless communication at an access point multi-link device (AP MLD), wherein the AP MLD includes a plurality of affiliated access points (APs), and the method comprises: in a multi-link scheduling power saving mode of the AP MLD, each affiliated AP of the plurality of affiliated APs entering an awake state at a first scheduling information frame to transmit scheduling information on its link, wherein the scheduling information indicates one or more service periods (SPs) after the first scheduling information frame for the plurality of affiliated APs, in each SP of the one or more SPs, only one affiliated AP in the plurality of affiliated APs entering the awake state.

In some embodiments, links of the plurality of affiliated APs are in the non-simultaneous transmit and receive (NSTR) operation mode.

In some embodiments, the scheduling information at least indicates one or more of the following items related to the SPs: working states of the plurality of affiliated APs in the one or more SPs, wherein the working states include awake state and doze state, starting times of the one or more SPs, and time durations of the one or more SPs.

In some embodiments, the first scheduling information frame is associated with a first target beacon transmission time (TBTT).

In some embodiments, ends of the one or more SPs are aligned with TBTTs, respectively, time durations of one or more SPs are determined based on an interval of the beacon frames.

In some embodiments, each affiliated AP of the plurality of affiliated APs entering the awake state at one or more TBTTs after the first scheduling information frame.

At least based on the above embodiments of the present disclosure, an improved mechanism of power saving for the AP MLD is provided. The present disclosure is to leverage the characteristic of the scheduling information which is transmitted by each affiliated APs of the AP MLD. Thus, the AP MLD can support the scheduling of non-MLD STA connected to the AP MLD in the power saving mode.

### BRIEF DESCRIPTION OF DRAWINGS

The above and other aspects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements. In the accompanying drawings.

FIG. 1 is a schematic block diagram of an AP MLD according to one embodiment of the present disclosure;

FIG. 2 is a schematic diagram of the AP MLD is only associated with the STA which supported the TWT mechanism according to one embodiment of the present disclosure.

FIG. 3 is a diagram illustrating an example of the scheduling information transmitted by the plurality of affiliated access points (APs) in accordance with the present disclosure;

FIG. 4 shows a flowchart illustrating a method for wireless communication at an AP MLD in accordance with one embodiment of the present disclosure;

FIG. 5 shows a flowchart illustrating a method for wireless communication at an AP MLD in accordance with another embodiment of the present disclosure;

FIG. 6 is a schematic block diagram of an AP according to one embodiment of the present disclosure.

FIG. 7 is a schematic block diagram of an AP according to another embodiment of the present disclosure.

### DETAILED DESCRIPTION

The technical solution of the present disclosure will be clearly and completely described below in conjunction with accompanying drawings. The described embodiments are part of the embodiments of the present disclosure, but not all of them. Based on the embodiments in the present disclosure, all other embodiments acquired by ordinary skilled in the art without making any creative efforts fall within the scope of protection of the present disclosure.

Some of the drawings may not depict all the components of a given method, device, and system. Like reference numerals may be used to denote like features throughout the specification and drawings.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined with each other as long as no conflicts occur therebetween.

In the present disclosure, an AP, which may be interchangeably referred to as a wireless access point (WAP), is a communication device that can communicate with a non-AP (e.g., an STAtion (STA) or client device) in a WLAN and that allows the non-AP to connect to a wired network. The AP usually connects to a router (via a wired network) as an STAndalone device, but it can also be integrated with or employed in the router.

Likewise, in the present disclosure, a non-AP (e.g., a client device or station, which is interchangeably referred to as an STA) is a communication device that can communicate with an AP to obtain various communication services such as voice, video, packet data, messaging, broadcast, etc. The STA can be any device that contains an IEEE 802.11-conformant media access control (MAC) and physical layer (PHY) interface to the wireless medium (WM). For example, an STA may be a laptop, a desktop personal computer (PC), a personal digital assistant (PDA), an access point, or a Wi-Fi phone in a WLAN environment. The STA may be fixed or mobile. In the WLAN environment, the terms “STA”, “client device”, “wireless client”, “user” and “user device”are often used interchangeably.

In the present disclosure, an STA in a WLAN may work as an AP on a different occasion, and vice versa. This is because communication devices in the context of IEEE 802.11 (Wi-Fi) technologies may include both STA hardware components and AP hardware components. In this manner, the communication devices may switch between an STA mode and an AP mode, based on actual WLAN conditions and/or requirements. In various embodiments below, a non-AP STA may refer to an STA in a WLAN that is not implemented as an AP.

As previously mentioned, in the next-generation Wi-Fi standard proposals, the current power saving schemes cannot be applied to the links to the non-MLD STAs. For example, according to the current power saving schemes, only one link is kept in the active mode, and the non-MLD STA which is connected to the AP MLD with one of the multiple links may be not possible to receive the beacon frame from the AP MLD, and cannot transmit data to the AP MLD. At the same time, the non-MLD STA may lose the synchronization which causes the disconnection with the AP MLD. Therefore, the current power saving schemes of the AP MLD are not compatible with the non-MLD STA.

In view of at least the above problem, the overall concept of the present disclosure is to leverage the characteristic of the scheduling information which is transmitted by each affiliated APs of the AP MLD, and the awake timing of the plurality of affiliated APs in the AP MLD. Thus, the AP MLD can support the scheduling of the non-MLD STAs connected to the AP MLD in the power saving mode.

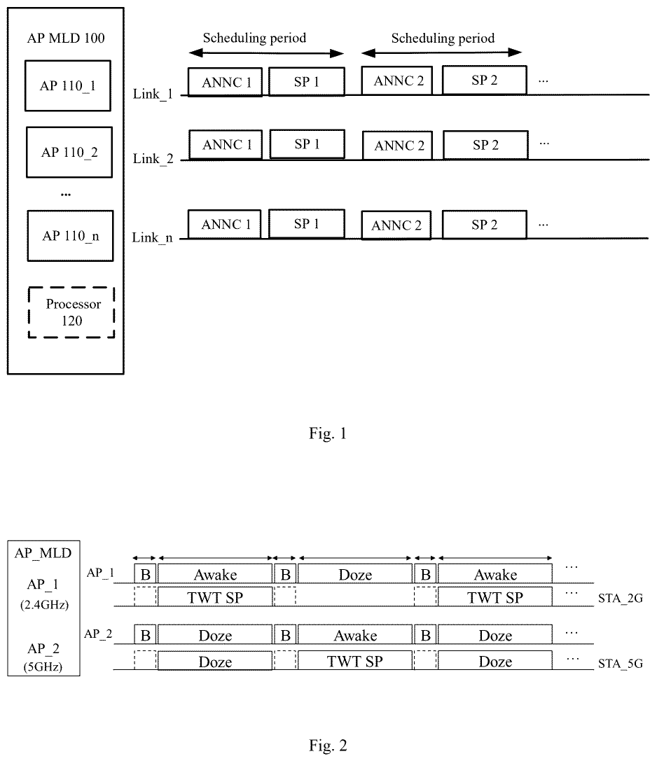

FIG. 1 is a schematic block diagram of an AP MLD 100 according to one embodiment of the present disclosure. The AP MLD 100 may include a plurality of affiliated access points (APs), i.e. the affiliated AP 110_1, the affiliated AP 110_2, . . . the affiliated AP 110_n. Each affiliated AP may work on its own link. As shown in FIG. 1, the affiliated access point 110_1 may transmit or receive information on the Link_1, the affiliated access point 110_2 may transmit or receive information on the Link_2, . . . and the affiliated access point 110_n may transmit or receive information on the Link_n. In one example of the present disclosure, the affiliated APs may work on the same or different frequencies. For example, the affiliated AP 110_1 may work on 2.4 GHz, and the affiliated AP 110_2 may work on 5 GHz.

As shown in FIG. 1, in the multi-link scheduling power saving mode of AP MLD, one or more scheduling periods may be included. A scheduling period may include a scheduling information frame, which may be also called as announcement frame (ANNC), and a service period (SP). The scheduling information frame may be transmitted based on the target beacon transmission time (TBTT). At the TBTT, a beacon frame is transmitted. The STA can maintain the synchronization with the AP MLD based on the received beacon frame. Alternitively, The scheduling information frame may be transmitted independently from the target beacon transmission time (TBTT). Moreover, during the service period, the affiliated AP in the awake state can provide service.

According to the embodiment of the present disclosure, each affiliated AP of the plurality of affiliated APs may be in an awake state to transmit the ANNC frame including thescheduling information on its link, wherein the scheduling information indicates one or more SPs after the first scheduling information frame for the plurality of affiliated APs. In the example shown in FIG. 1, the affiliated access points 110_1, 110_2, . . . 110_n are in the awake state to transmit a ANNC frame including the scheduling information on Link_1, Link_2, . . . Link_n respectively. The scheduling information transmitted in the ANNC frame may indicate one or more SPs.

For example, as shown in FIG. 1, the scheduling information transmitted in the ANNC frame indicates one SP. That is, the scheduling information transmitted in the ANNC 1 indicates SP 1, the scheduling information transmitted in the ANNC 2 indicates SP 2. Alternatively, the scheduling information transmitted in the ANNC 1 may indicate SP 1 and SP 2. In this case, there is not necessary to transmit the scheduling information for SP2.after the first scheduling information frame The scheduling information transmitted by the affiliated access points 110_1, 110_2, . . . 110_n may be the same. Thus, the STA on each link of the AP MLD 110 can receive the scheduling information.

Moreover, according to an example of the present disclosure, the links of the plurality of affiliated APs in FIG. 1 are in the non-simultaneous transmit and receive (NSTR) operation mode. Thus, the plurality of affiliated APs of the AP MLD can transmit the scheduling information at the same time.

In each SP of one or more SPs, only one affiliated AP in the plurality of affiliated APs is in an awake state.

According to an example of the present disclosure, the scheduling information indicates one or more of the following items related to the SPs: working states of the plurality of affiliated APs in the one or more SPs, wherein the working states include awake state and doze state, starting times of the one or more SPs, and time durations of the one or more SPs. For example, in the embodiment of FIG. 1, the scheduling information transmitted in the ANNC 1 may indicate that the affiliated access point 110_1 awakes in the SP 1, and other the affiliated access points are unavailable or enter the doze state, in which the affiliated AP does not provide the access service. Moreover, the scheduling information transmitted in the ANNC 1 may also indicate the starting time and time duration of SP 1.

According to one aspect of the present disclosure, the first scheduling information frame is associated with a first target beacon transmission time (TBTT). For example, the scheduling information may be included in the beacon. In this case, the first scheduling information frame is the first beacon frame which is transmitted at a TBTT. For another example, the, the scheduling information frame may be an independent frame which is transmitted after the beacon. frame. Moreover, the time durations of one or more SPs are determined based on an interval of the beacon frames. And, the ends of one or more SPs are aligned with TBTTs. For example, the time duration of an SP may be equal to the interval of the beacon frames, or the time duration of an SP may be a multiple of the interval of beacon frames. Optionally, when the affiliated SP connected with a legacy STA is in awake state during the SP, the time duration of the SP may be equal to the interval of the beacon frames. Moreover, the time duration of an SP may be determined based on the type of one or more STAs associated with the affiliated AP, the quantity of the STAs associated with each affiliated AP, and/or the traffic load of one or more STAs associated with each affiliated AP. Furthermore, each affiliated AP of the plurality of affiliated APs is in the awake state at one or more TBTTs after the first scheduling information frame is transmitted. Thus, the legacy STA which is connected on any link of the AP MAD may maintain the the synchronization with the AP MAD.

According to another aspect of the present disclosure, the plurality of affiliated APs of the AP MLD may enter the awake state in an order during a plurality of successive SPs in the multi-link scheduling power saving mode. For example, in the embodiment of FIG. 1, the affiliated access point 110_1 may be in the awake state in SP 1, the affiliated access point 110_2 may be in the awake state in SP 2, . . . the affiliated access point 110_n may be in the awake state in the SP n. Thus, in the multi-link scheduling power saving mode of the AP MLD, the non-MLD STA connected with any of the affiliated APs in the AP MLD can be proved service by the AP MLD. Moreover, the awakened AP may provide services like sounding response, authentication, association, etc. for the newly connected legacy device.

Optionally, the order of entering the awake state for the plurality of affiliated APs may be determined based on one or more of the following items: a type of one or more STAs associated with each affiliated AP, a quantity of one or more STAs associated with each affiliated AP, a traffic load of one or more STAs associated with each affiliated AP. For example, if the affiliated AP 110_1 may work on 2.4 GHz, the affiliated AP 110_2 may work on 5 GHz, and the AP MLD is associated with a 2.4 GHz non-MLD STA and a dual-band STA MLD which works on 2.4 GHz and 5 GHz, then the affiliated AP 110_1 provides services for the 2.4 GHz non-MLD STA and STA MLD at 2.4 GHz, and the affiliated AP 110_2 provides service for the STA MLD at 5 GHz. In this case, the duration of the SP in which the affiliated AP 110_1 is in the awake state may be longer than that of the SP in which the affiliated AP 110_2 is in the awake state. Thus, the efficiency of power saving may be further improved.

According to one embodiment of the present disclosure, the scheduling information may indicate one SP after the first scheduling information frame for the plurality of affiliated APs, and the plurality of affiliated APs transmit another scheduling information for the next SP. As mentioned above, in the embodiment of FIG. 1, the scheduling information transmitted in the ANNC 1 may only indicate SP 1. In this case, the affiliated access points 110_1, 110_2, . . . 110_n transmit another scheduling information in the ANNC 2 for indicating SP 2.

According to another embodiment of the present disclosure, the scheduling information may indicate a plurality of SPs after the first scheduling information frame for the plurality of affiliated APs. Thus, the plurality of affiliated APs do not need to transmit the new scheduling information in for each SP. For example, as mentioned above, the scheduling information transmitted in the ANNC 1 may only indicate SP 1 and SP 2. In this case the affiliated access points 110_1, 110_2, . . . 110_n do not transmit other scheduling information in the ANNC 2 for indicating SP 2.

On the other hand, although the affiliated access points may not need to transmit the scheduling information at a TBTT, the affiliated access points enter the awake state at each TBTT in the SP, such that the affiliated access points can transmit the beacon frame at the TBTT. Moreover, in this case, the scheduling information may further indicate the number of the SPs corresponding to the scheduling information.

According to another embodiment of the present disclosure, the scheduling information is not necessary to be transmitted based on the TBTT. For example, if the AP MLD is only associated with the STA which supported the target wake time (TWT) mechanism, the plurality of affiliated APs of the AP MLD may transmit the scheduling information at any time, and there is not necessary to transmit the scheduling information based on the TBTT. Specifically, according to the TWT scheduling mechanism, the TWT SP of the STA is within the time duration in which the associated affiliated AP of the STA is in the awake state. Thus, when the STA awakes in the TWT SP, its associated affiliated AP is also in the awake state.

FIG. 2 is a schematic diagram of the AP MLD is only associated with the STA which supported the TWT mechanism according to one embodiment of the present disclosure. As shown in FIG. 2, the TWT SP of the STA is align with the time duration in which the associated affiliated AP of the STA is in the awake state. Moreover the B frame in FIG. 2 refers to the beacon frame which is transmitted at the TBTT. In example shown by FIG. 2, the scheduling information is not necessary to be transmitted based on the TBTT. Moreover, the starting time of the time duration in which the associated affiliated AP of the STA is in the awake state may be not immediately after the beacon frame.

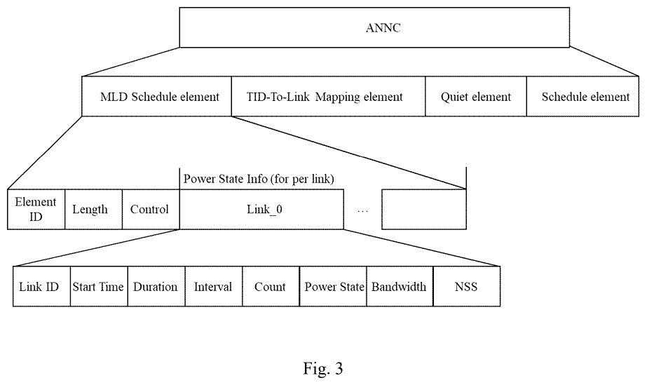

FIG. 3 is a diagram illustrating an example of the scheduling information transmitted by the plurality of affiliated access points (APs) in accordance with the present disclosure. As shown in FIG. 3, the scheduling information transmitted by the plurality of affiliated access points (APs) in the multi-link scheduling power saving mode of the AP MLD may be marked as ANNC, which comprises MLD Schedule element, TID-To-Link Mapping element, Quiet element and Schedule element. The MLD Schedule element may include the Element ID field, Length field, Control field, and the Power State Info field which indicates the Power State of each link. The Element ID field may be used to indentify the element. The Length field may indicate the bytes of the element. The Control element may indicate the number of link scheduled by the element. For each link, the Power State Info field may include the sub-fields of Link ID, Start Time, Duration, Interval, Count, Power State, Bandwidth, and number of spatial streams (NSS). The sub-fields of Start Time and Duration may indicate the starting time and duration of the SP respectively. The sub-field of Count may indicate the number of the SPs corresponding to the scheduling information. Moreover, the sub-field of Power State may indicate the mode of the link (which may correspond to the working mode of the affiliated AP).

Moreover, the traffic indication map (TIM) element may indicate an STAtus of a buffer of the affiliated AP associated with the non-MLD STAs by a virtual bitmap. When there is data in the buffer of the affiliated AP, the affiliated AP may wait for the non-MLD STA to retrieve the buffer before entering the next scheduling process if the TIM transmission mechanism is applied; otherwise, if there is no data in the buffer, the next scheduling process may be carried out immediately.

Furthermore, when an affiliated AP is associated with one or more non-MLD STAs and one or more non-MLD STAs are in the active mode, the scheduling information includes a quiet element or a schedule element, such that the non-MLD STA does not transmit the frame to the associated affiliated AP when the associated affiliated AP is in the doze state.

In another example, one or more elements shown in FIG. 3 may be combined according to the type of the non-AP STA associated with the AP MLD. Moreover, the scheduling information shown in FIG. 3 may be transmitted in a separate scheduling information frame or may be included in other management frames for transmission.

According to another embodiment of the present disclosure, the AP MLD 100 may further include a processor 120 to control the AP MLD 100 to enter the multi-link scheduling power saving mode, and schedule working states of the plurality of affiliated APs 110_1, 110_2, . . . 110_n in the multi-link scheduling power saving mode, wherein the working states include the awake state and a doze state. For example, processor 120 may control the AP MLD 100 to enter the multi-link scheduling power saving mode based on a traffic load of the AP MLD 100, a transmission delay of the AP MLD 100, and/or a type of a non-AP STA associated with the AP MLD 100. Moreover, the processor 120 may control the AP MLD 100 to enter the multi-link scheduling power saving mode also based on the scheduling established by the AP MLD 100 or the mapping information of the AP MLD 100. Specifically, the mapping information may indicate the traffic mapping established between the STA MLD and the AP MLD.

Alternatively, in the multi-link scheduling power saving mode, the processor may schedule an affiliated AP to enter the awake state when one or more non-MLD STAs associated with the affiliated AP enter the awake state. Thus, the awake time of the non-MLD STA may be aligned with that of the affiliated AP associated with the non-MLD STA. That is, the affiliated AP and STA on the same link are in the awake state at the same time, such that the affiliated AP can provide the access service to the STA.

Alternatively, after the AP MLD 100 enters the multi-link scheduling power saving mode, the processor 120 may switch the plurality of affiliated AP to the awake state. According to an embodiment of the present disclosure, the processor is further configured to switch the plurality of affiliated AP to the awake state, in response to the request frame, when the affiliated AP in the awake state during an SP receives a request frame from an STAtion (STA) MLD. For example, when the STA MLD associated with the AP MLD 100 has a large traffic transmission requirement, the STA MLD may send a request frame to the corresponding affiliated AP on the link in the awake state. The processor 120 may stop the multi-link scheduling power saving mode, and control all of the affiliated APs entering the awake state in response to the request frame. Additionally, after completing the large traffic transmission and the current SP has not expired, the awakened affiliated AP may enter the doze state again. According to another embodiment of the present disclosure, after the AP MLD 100 enters the multi-link scheduling power saving mode, the processor 120 may stop the multi-link scheduling power saving mode, when one or more of the conditions for entering the multi-link scheduling power saving mode are not satisfied.

According to an embodiment of the present disclosure, when an affiliated AP is scheduled in the doze state, the non-MLD STA associated with the affiliated AP may have a low latency traffic transmission requirement. Moreover, one or more legacy STAs may be associated with the affiliated AP which is scheduled in the doze state. The legacy STA may refer to the STA which comply with the previous version of the Wi-Fi standard. For example, the legacy STA may refer to the STA which comply with the IEEE 802.11 with the version of or before 802.11n and one or more legacy STAs are in the awake state. The legacy STA may not support the low latency traffic transmission. In this case, the affiliated AP associated with the non-MLD STA having a low latency traffic transmission requirement or the legacy STA may switch to the lower capability mode in which a transmission capability of an AP is reduced, instead of entering the dozing state. For example, in the lower capacity mode, the affiliated AP may work at 20 MHz with 1 NSS. For another example, in the lower capacity mode, when the affiliated AP receives a request frame from an STA, the affiliated AP switch to the higher capacity mode for transmitting the low latency traffic.

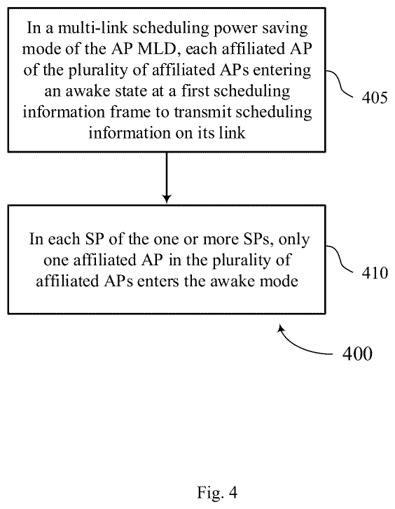

FIG. 4 shows a flowchart illustrating a method 300 for wireless communication at an AP MLD in accordance with one embodiment of the present disclosure. the AP MLD includes a plurality of affiliated APs. The operations of method 300 may be implemented by a AP or its MLD components as described herein. For example, the operations of method 300 may be performed by the AP MLD 100 as described with reference to FIGS. 1 through 3. In some examples, an AP MLD may execute a set of instructions to control the functional elements of the AP MLD to perform the functions described herein. Additionally or alternatively, an AP MAD may perform aspects of the functions described herein using special-purpose hardware.

At 405, in a multi-link scheduling power saving mode of the AP MLD, each affiliated AP of the plurality of affiliated APs enters an awake state to transmit ANNC frame including the scheduling information on its link, wherein the scheduling information indicates one or more SPs after the first scheduling information frame for the plurality of affiliated APs. The scheduling information transmitted by the plurality of affiliated APs may be the same. Thus, the STA on each link of the AP MLD can receive the scheduling information. The scheduling information transmitted in the ANNC frame may indicate one or more SPs. Moreover, according to an example of the present disclosure, the links of the plurality of affiliated APs are in the non-simultaneous transmit and receive (NSTR) operation mode. Thus, the plurality of affiliated APs of the AP MLD can transmit the scheduling information at the same time.

At 410, in each SP of one or more SPs, only one affiliated AP in the plurality of affiliated APs enters the awake state.

According to an example of the present disclosure, the scheduling information indicates one or more of the following items related to the SPs: working states of the plurality of affiliated APs in the one or more SPs, wherein the working states include awake state and doze state, starting times of the one or more SPs, and time durations of the one or more SPs.

According to one aspect of the present disclosure, the first scheduling information frame is associated with a first target beacon transmission time (TBTT). For example, the scheduling information may be included in the beacon. In this case, the first scheduling information frame is the first beacon frame which is transmitted at a TBTT. For another example, the, the scheduling information frame may be an independent frame which is transmitted after the beacon. frame. Moreover, the time durations of one or more SPs are determined based on an interval of the beacon frames. And, the ends of one or more SPs are aligned with TBTTs. For example, the time duration of an SP may be equal to the interval of the beacon frames, or the time duration of an SP may be a multiple of the interval of beacon frames. Optionally, when the affiliated AP connected with an STA is in awake state during the SP, the time duration of the SP may be equal to the interval of the beacon frames. Moreover, the time duration of an SP may be determined based on the type of one or more STAs associated with the affiliated AP, the quantity of the STAs associated with each affiliated AP, and/or the traffic load of one or more STAs associated with each affiliated AP. Furthermore, the method 300 may further comprise the step of each affiliated AP of the plurality of affiliated APs entering in the awake state at one or more TBTTs after the first scheduling information frame is transmitted. Thus, the legacy STA which is connected on any link of the AP MAD may maintain the the synchronization with the AP MAD.

According to another aspect of the present disclosure, the plurality of affiliated APs of the AP MLD may enter the awake state in an order during a plurality of successive SPs in the multi-link scheduling power saving mode. Thus, in the multi-link scheduling power saving mode of the AP MLD, the non-MLD STA connected with any of the affiliated APs in the AP MLD can be proved service by the AP MLD. Moreover, the awakened AP may provide services like sounding response, authentication, association, etc. for the newly connected legacy device.

Optionally, the order of entering the awake state for the plurality of affiliated APs may be determined based on one or more of the following items: a type of one or more STAs associated with each affiliated AP, a quantity of one or more STAs associated with each affiliated AP, a traffic load of one or more STAs associated with each affiliated AP.

According to one embodiment of the present disclosure, the scheduling information may indicate one SP after the first scheduling information frame for the plurality of affiliated APs, and the plurality of affiliated APs transmit another scheduling information for the next SP.

According to another embodiment of the present disclosure, the scheduling information may indicate a plurality of SPs after the first scheduling information frame for the plurality of affiliated APs. Thus, the plurality of affiliated APs do not need to transmit the new scheduling information for each TBTT.

On the other hand, although the affiliated access points may not need to transmit the scheduling information at a TBTT, the affiliated access points enter the awake state at each TBTT in the SP, such that the affiliated access points can transmit the beacon frame at the TBTT. Moreover, in this case, the scheduling information may further indicate the number of the SPs corresponding to the scheduling information.

According to another embodiment of the present disclosure, the scheduling information is not necessary to be transmitted based on the TBTT. For example, if the AP MLD is only associated with the STA which supported the target wake time (TWT) mechanism, the plurality of affiliated APs of the AP MLD may transmit the scheduling information at any time, and there is not necessary to transmit the scheduling information based on the TBTT. Specifically, according to the TWT scheduling mechanism, the TWT SP of the STA is within the time duration in which the associated affiliated AP of the STA is in the awake state. Thus, when the STA awakes in the TWT SP, its associated affiliated AP is also in the awake state.

According to another embodiment of the present disclosure, the AP MLD may determine whether enters the multi-link scheduling power saving mode. FIG. 4 shows a flowchart illustrating a method 400 for wireless communication at an AP MLD in accordance with another embodiment of the present disclosure. the AP MLD includes a plurality of affiliated APs.

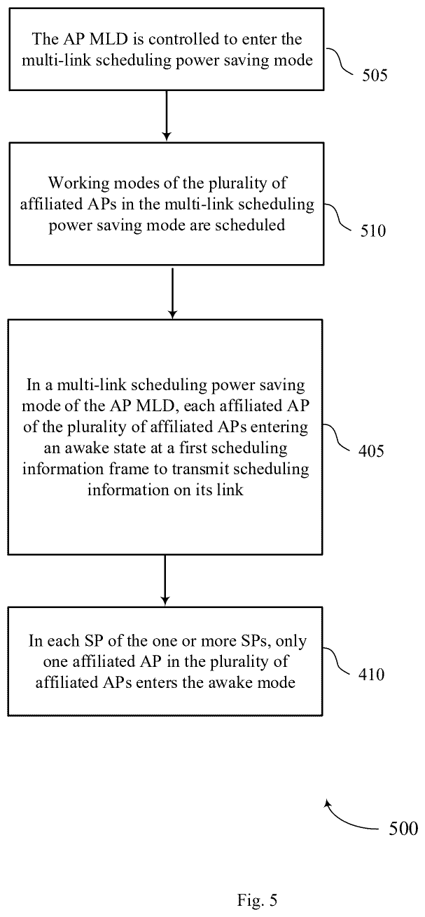

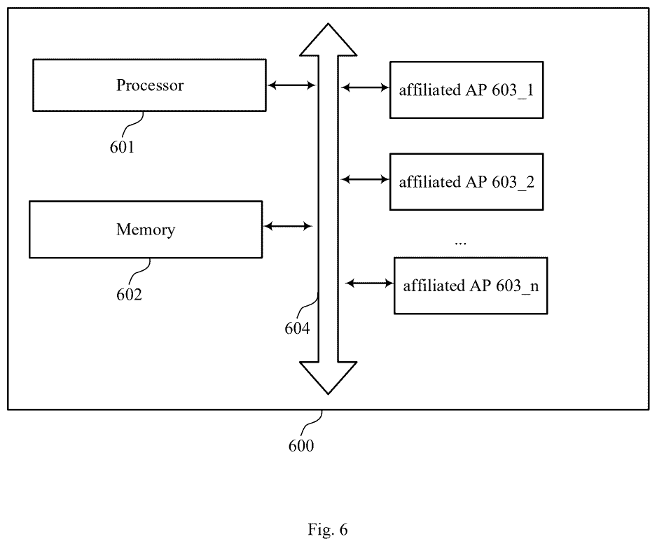

As shown in FIG. 5, at 505, the AP MLD is controlled to enter the multi-link scheduling power saving mode. For example, at 505, the AP MLD 100 may be determined to enter the multi-link scheduling power saving mode based on a traffic load of the AP MLD, a transmission delay of the AP MLD, and/or a type of a non-AP STA associated with the AP MLD. Moreover, at 405, the AP MLD 100 may be determined to enter the multi-link scheduling power saving mode also based on the scheduling established by the AP MLD or the mapping information of the AP MLD.

At 510, the working states of the plurality of affiliated APs in the multi-link scheduling power saving mode are scheduled, wherein the working states include the awake state and a doze state. For example, in the multi-link scheduling power saving mode, an affiliated AP may be scheduled to enter the awake state when one or more non-MLD STAs associated with the affiliated AP enter the awake state. Thus, the awake time of the non-MLD STA may be aligned with that of the affiliated AP associated with the non-MLD STA. That is, the affiliated AP and STA on the same link are in the awake state at the same time, such that the affiliated AP can provide the access service to the STA.

Alternatively, after the AP MLD enters the multi-link scheduling power saving mode, the method 400 may further include the step of switching the the plurality of affiliated AP to the awake state. According to an embodiment of the present disclosure, the plurality of affiliated AP may be switched to the awake state, in response to the request frame, when the affiliated AP in the awake state during an SP receives a request frame from an STAtion (STA) MLD. For example, when the STA MLD associated with the AP MLD has a large traffic transmission requirement, the STA MLD may send a request frame to the corresponding affiliated AP on the link in the awake state. The method 400 may include the step of stopping the multi-link scheduling power saving mode, and controlling all of the affiliated APs to enter the awake state in response to the request frame. Additionally, after completing the large traffic transmission and the current SP has not expired, the method 400 may include the step of scheduling the awakened affiliated AP may enter the doze state again. According to another embodiment of the present disclosure, after the AP MLD 100 enters the multi-link scheduling power saving mode, the method 400 may further include the step of determining whether one or more of the conditions for entering the multi-link scheduling power saving mode are satisfied, and stopping the multi-link scheduling power saving mode, when one or more of the conditions for entering the multi-link scheduling power saving mode are not satisfied.

According to an embodiment of the present disclosure, when an affiliated AP is scheduled in the doze state, the non-MLD STA associated with the affiliated AP may have a low latency traffic transmission requirement. Moreover, one or more legacy STAs may be associated with the affiliated AP which is scheduled in the doze state. The legacy STA may refer to the STA which comply with the previous version of the Wi-Fi standard. For example, the legacy STA may refer to the STA which complies with the IEEE 802.11 with the version of or before 802.11n and the one or more legacy STAs are in the awake state. The legacy STA may not support the low latency traffic transmission. In this case, the method 400 may further include the step of switching the affiliated AP associated with the non-MLD STA having a low latency traffic transmission requirement or the legacy STAmay switch to the lower capability mode. For another example, in the lower capacity mode, when the affiliated AP receives a request frame from an STA, the method 400 may further include the step of the affiliated AP switching to the higher capacity mode for transmitting the low latency traffic. Moreover, the steps 405, and 410 in FIG. 5 are described in FIG. 4, thus, the details are omitted.

FIG. 6 is a schematic block diagram of an AP 600 according to one embodiment of the present disclosure. It should be noted that AP 600 depicted in FIG. 6 may correspond to the AP MLD as described above and may be used to perform the operations related to the multi-link scheduling power saving mode as described in the above with respect to method 400.

As shown in FIG. 6, AP 600 may comprise processor 601, and memory 602, and affiliated APs 603_1, 603_2, and 603_3. These components may be in electronic communication via one or more buses (e.g., bus 604). Processor 601 is communicatively coupled with the memory and configured to perform steps 505 and 510 in method 500 as discussed above.

Examples of processor 601 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

Processor 501 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 602.

Memory 602 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software (e.g. code and/or instructions) that may be accessed and read by a computer. Memory 602 may reside in processor 601, external to processor 601, or distributed across multiple entities including processor 601.

Memory 602 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

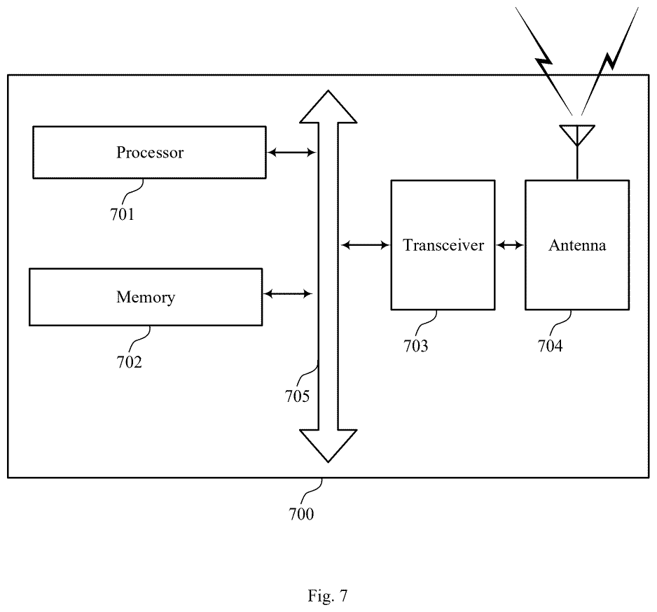

FIG. 7 is a schematic block diagram of an AP 700 according to another embodiment of the present disclosure. It should be noted that AP 700 depicted in FIG. 6 may correspond to the affiliated AP as described above and may be used to perform the operations related to the multi-link scheduling power saving mode as described in the above with respect to method 400 and method 500.

As shown in FIG. 7, AP 700 may comprise processor 701, memory 702, a transceiver 703, an antenna 704. These components may be in electronic communication via one or more buses (e.g., bus 705). Processor 701 is communicatively coupled with the memory and configured to perform steps 405, 410, and 415 in method 400 or method 500 discussed above.

Examples of processor 701 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

Processor 601 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 702.

Memory 702 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software (e.g. code and/or instructions) that may be accessed and read by a computer. Memory 702 may reside in processor 701, external to processor 701, or distributed across multiple entities including processor 701.

Memory 702 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

The transceiver 703 may communicate bi-directionally, via one or more antennas, wired, or wireless links as described herein. For example, the transceiver 703 may represent a wireless transceiver and may communicate bi-directionally with another wireless transceiver. The transceiver 703 may also include a modem to modulate the packets and provide the modulated packets to the antennas for transmission, and to demodulate packets received from the antennas. In some cases, the wireless device may include a single antenna 704. However, in some cases the device may have more than one antenna 704, which may be capable of concurrently transmitting or receiving multiple wireless transmissions.

In addition, according to another embodiment of the present disclosure, a computer program product for controlling the bandwidth of a channel including a plurality of subchannels is disclosed. As an example, the computer program product comprises a non-transitory computer readable storage medium having program instructions embodied therewith, and the program instructions are executable by a processor. When executed, the program instructions cause the processor to perform one or more of the procedures above described, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

An expression such as “according to”, “based on”, “depend on”, and so on as used in the disclosure does not mean “according only to”, “based only on”, or “dependent only on”, unless it is explicitly otherwise stated. In other words, such expression generally means “according at least to”, “based at least on”, or “depend at least on”in the disclosure.

Any reference in the disclosure to an element using the designation “first”, “second” and so forth is not intended to comprehensively limit the number or order of such elements. These expressions may be used in the disclosure as a convenient method for distinguishing two or more units. Thus, a reference to a first unit and a second unit does not imply that only two units may be employed or that the first unit must precede the second unit in some form.

The term “determining”used in the disclosure may include various operations. For example, regarding “determining”, calculating, computing, processing, deriving, investigating, looking up (e.g., looking up in tables, databases, or other data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth may also be regarded as “determining”. That is, regarding “determining”, several actions may be regarded as “determining”.

The terms such as “connected”, “coupled” or any of their variants used in the disclosure refer to any connection or combination, direct or indirect, between two or more units, which may include the following situations: between two units that are “connected” or “coupled” with each other, there are one or more intermediate units. The coupling or connection between the units may be physical or logical or may also be a combination of the two. As used in the disclosure, two units may be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

It should be noted that the above description is only some embodiments of the present disclosure and an illustration of the applied technical principles. It should be understood by those skilled in the art that the present disclosure scope involved in the present disclosure is not limited to the technical solutions resulting from specific combinations of the above technical features, but also encompasses other technical solutions resulting from any combination of the above technical features or their equivalents without departing from the above disclosed concept, for example, the technical solutions formed by replacing between the above features and the technical features with similar functions disclosed in the present disclosure (but not limited hereto).

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. An access point multi-link device (AP MLD), comprising a plurality of affiliated access points (APs), wherein in a multi-link scheduling power saving mode,
each affiliated AP of the plurality of affiliated APs is in an awake state at a first scheduling information frame to transmit scheduling information on its link, wherein the scheduling information indicates one or more service periods (SPs) after the first scheduling information frame for the plurality of affiliated APs,
in each SP of the one or more SPs, only one affiliated AP in the plurality of affiliated APs is in an awake state.

2. The AP MLD of claim 1, wherein the scheduling information indicates one or more of the following fields related to the SPs:
working states of the plurality of affiliated APs in the one or more SPs, wherein the working states include awake state and doze state,
starting times of the one or more SPs, and
time durations of the one or more SPs.

3. The AP MLD of claim 2, wherein
the first scheduling information frame is associated with a first target beacon transmission time (TBTT).

4. The AP MLD of claim 3, wherein
ends of the one or more SPs are aligned with TBTTs, respectively,
time durations of the one or more SPs are determined based on an interval of the beacon frames.

5. The AP MLD of claim 3, wherein
each affiliated AP of the plurality of affiliated APs is in the awake state at one or more TBTTs after the first scheduling information frame.

6. The AP MLD of claim 2, wherein
the AP MLD schedules one or more STAs for being in the awake mode during the SP when an affiliated AP which associated with the one or more STAs is in awake state, with negotiating target wake time (TWT) agreements, and
the first scheduling information frame is independent from a target beacon transmission time (TBTT).

7. The AP MLD of claim 2, wherein in the multi-link scheduling power saving mode,
when a first affiliated AP is in the doze state, and the first affiliated AP is associated with one or more non-MLD STAs that require low latency transmission service or associated with one or more legacy STAs in the awake state, the first affiliated AP switches to the lower capability mode in which a transmission capability of an AP is reduced, and
the one or more legacy STAs do not support the low latency traffic transmission.

8. The AP MLD of claim 1, further comprising
a processor configured to control the AP MLD to enter the multi-link scheduling power saving mode, and schedule working states of the plurality of affiliated APs in the multi-link scheduling power saving mode, wherein the working states include the awake state and a doze state.

9. The AP MLD of claim 8, wherein in the multi-link scheduling power saving mode,
the processor is further configured to switch the plurality of affiliated APs to the awake state, in response to the request frame, when the affiliated AP in the awake state during an SP receives a request frame from an STAtion (STA) MLD.

10. The AP MLD of claim 8, wherein
the processor is further configured to control the AP MLD to enter the multi-link scheduling power saving mode based on a traffic load of the AP MLD, a transmission delay of the AP MLD, and/or a type of a non-AP STA associated with the AP MLD.

11. The AP MLD of claim 8, wherein
in the multi-link scheduling power saving mode, the processor is further configured to schedule a second affiliated AP to enter the awake state when one or more non-MLD STAs associated with the second affiliated AP enter the awake state.

12. The AP MLD of claim 8, wherein the scheduling information further indicates:
a number of the SPs corresponding to the scheduling information.

13. The AP MLD of claim 1, wherein
the plurality of affiliated APs enter the awake state in an order during a plurality of successive SPs in the multi-link scheduling power saving mode.

14. The AP MLD of claim 13, wherein the order is determined based on one or more of the following items:
a type of one or more STAs associated with each affiliated AP,
a quantity of one or more STAs associated with each affiliated AP,
a traffic load of one or more STAs associated with each affiliated AP.

15. The AP MLD of claim 1, wherein
when a third affiliated AP is associated with one or more STAs and the one or more STAs are in the active mode, the scheduling information includes a quiet element, a schedule element or TID-To-Link Mapping element for the third affiliated AP.

16. The AP MLD of claim 1, wherein
links of the plurality of affiliated APs are in the non-simultaneous transmit and receive (NSTR) operation mode,

17. A method for wireless communication at an access point multi-link device (AP MLD), wherein the AP MLD includes a plurality of affiliated access points (APs), and the method comprises:
in a multi-link scheduling power saving mode of the AP MLD, each affiliated AP of the plurality of affiliated APs entering an awake state at a first scheduling information frame to transmit scheduling information on its link, wherein the scheduling information indicates one or more service periods (SPs) after the first scheduling information frame for the plurality of affiliated APs;
in each SP of the one or more SPs, only one affiliated AP in the plurality of affiliated APs entering the awake state.

18. The method of claim 17, wherein the scheduling information at least indicates one or more of the following items related to the SPs:
working states of the plurality of affiliated APs in the one or more SPs, wherein the working states include awake state and doze state,
starting times of the one or more SPs, and
time durations of the one or more SPs.

19. The method of claim 18, wherein
the first scheduling information frame is associated with a first target beacon transmission time (TBTT).

20. The method of claim 19, wherein
ends of the one or more SPs are aligned with TBTTs, respectively,
time durations of the one or more SPs are determined based on an interval of the beacon frames.
